(19) United States
(12) Patent Application Publication
(10) Pub. No.: US 2018/0349885 A1
(43) Pub. Date: Dec. 6, 2018

(54) MOBILE DEVICE, METHOD, COMPUTER PROGRAM PRODUCT AND ISSUANCE SYSTEM FOR CONFIGURING TICKET CO-BRANDED CREDIT CARD BASED ON TOKENIZATION TECHNOLOGY

(71) Applicant: Chunghwa Telecom Co., Ltd., Taoyuan City (TW)

(72) Inventors: Yih-Chyau Kuo, Taoyuan City (TW); Cheng-Chun Yu, Taoyuan City (TW); Hong-Jen Chang, Taoyuan City (TW); Yen-Hsu Chiang, Taoyuan City (TW); Yeou-Fuh Kuan, Taoyuan City (TW); Char-Shin Miou, Taoyuan City (TW)

(73) Assignee: Chunghwa Telecom Co., Ltd., Taoyuan City (TW)

(21) Appl. No.: 15/705,272

(22) Filed: Sep. 15, 2017

(30) Foreign Application Priority Data
Jun. 2, 2017 (TW) 106118201

(51) Int. Cl. G06Q 20/34; G06Q 20/40

(52) U.S. Cl. CPC G06Q 20/34; G06Q 20/40

(57) ABSTRACT

The invention provides a mobile device, a method, a computer program product, and an issuance system for configuring a ticket co-branded credit card based on tokenization technology. The method includes the following steps. The mobile device is communication connected to a token service provider (TSP) and a trusted service manager (TSM). The TSP connects to a card issuer, and the TSM connects to a ticket issuer. Next, the mobile device transmits a ticket co-branded credit card request to the TSP so as to trigger the TSP to return a corresponding credit card token, and a ticket co-branding request is submitted to the ticket issuer via the card issuer, so that the ticket issuer returns an electronic ticket associated with the credit card token via the TSM. Through the above operation, security and convenience in use of a credit card can be effectively enhanced.

### CROSS-REFERENCE TO RELATED APPLICATION

This application claims the priority benefit of Taiwan application serial no. 106118201, filed on Jun. 2, 2017. The entirety of the above-mentioned patent application is hereby incorporated by reference herein and made a part of this specification.

### BACKGROUND OF THE INVENTION

### Field of the Invention

The invention involves a credit card management technical solution, particularly to a technical solution for configuring a ticket co-branded credit card based on tokenization technology.

### Description of Related Art

In traditional ticket co-branded credit card technology, a co-branded credit card is primarily identified by a magnetic strip, an intelligence chip, a printed text or the like on a plastic card. Production of the plastic card requires constant production costs, and it is very inconvenient for a cardholder to carry with them a plurality of different co-branded credit cards of a plurality of different banks.

In terms of transaction security, since traditional ticket co-branded credit cards are likely to expose real card numbers during a transaction, peoples' willingness to use the credit cards and card issuers' willingness to issue them are reduced.

To sum up, how to provide a solution to the aforementioned problems is a technical problem in this field which requires urgent attention.

### SUMMARY OF THE INVENTION

The invention provides a technical solution for configuring a ticket co-branded credit card based on tokenization technology.

The invention proposes a mobile device for configuring a ticket co-branded credit card based on tokenization technology. The mobile device includes a communication module, an operation interface, and a processing module. The communication module is communication connected to an external token service provider (TSP) and an external trusted service manager (TSM), wherein the TSP connects to an external card issuer, and the TSM connects to an external ticket issuer. The processing module is connected to the communication module and the operation interface, wherein the processing module acquires configurations of a ticket co-branded credit card via the operation interface, i.e., the communication module transmits a ticket co-branded credit card request to the TSP so as to trigger the TSP to return a corresponding credit card token file, and a ticket co-branding request is submitted to the ticket issuer via the card issuer, so that the ticket issuer returns an electronic ticket associated with the credit card token file via the TSP.

The invention further proposes a method for configuring a ticket co-branded credit card based on tokenization technology. The method operates in a mobile device and includes the following steps. First of all, the mobile device is communication connected to an external token service provider (TSP) and an external trusted service manager (TSM), wherein the TSP connects to an external card issuer, and the TSM connects to an external ticket issuer. Next, the mobile device transmits a ticket co-branded credit card request to the TSP so as to trigger the TSP to return a corresponding credit card token file, and a ticket co-branding request is submitted to the ticket issuer via the card issuer, so that the ticket issuer returns an electronic ticket associated with the credit card token file via the TSM.

The invention further proposes a computer program product for configuring a ticket co-branded credit card based on tokenization technology, wherein when the computer program product is loaded and executed by a computer, the above-mentioned method is completed.

The invention further proposes an issuance system for configuring a ticket co-branded credit card based on tokenization technology. The issuance system includes a card issuer, a token service provider (TSP), a ticket issuer, and a trusted service manager (TSM). The TSP connects to the card issuer. The TSM connects to the ticket issuer. The TSP acquires a ticket co-branded credit card request from an external mobile device and transmits a corresponding credit card token file to the mobile device, and the card issuer submits a ticket co-branding request to the ticket issuer, so that the ticket issuer returns an electronic ticket associated with the credit card token file to the mobile device via the TSM.

To sum up, in the invention, a general transaction and a ticket transaction are carried out through configuration of a credit card token and a corresponding electronic ticket. Therefore, security and convenience in use of a credit card can be effectively enhanced.

### BRIEF DESCRIPTION OF THE DRAWINGS

FIG. 1 is a system block diagram of a mobile device for configuring a ticket co-branded credit card based on tokenization technology according to a first embodiment of the invention.

FIG. 2 is a system block diagram of a mobile device for configuring a ticket co-branded credit card based on tokenization technology according to another embodiment of the invention.

FIG. 3 is a method flowchart of a method for configuring a ticket co-branded credit card based on tokenization technology according to a second embodiment of the invention.

FIG. 4 is a system block diagram of an issuance system for configuring a ticket co-branded credit card based on tokenization technology according to a fourth embodiment of the invention.

FIG. 5 is a flowchart of an exemplary embodiment of the invention.

FIG. 6 is a schematic diagram of an operation interface of the mobile device according to the invention.

FIG. 7 is a schematic diagram of an application scenario according to the invention.

### DETAILED DESCRIPTION OF DISCLOSED EMBODIMENTS

Specific embodiments will be described below in order to explain manners of implementation of the invention, but these embodiments are not intended to limit the scope of protection sought for the invention.

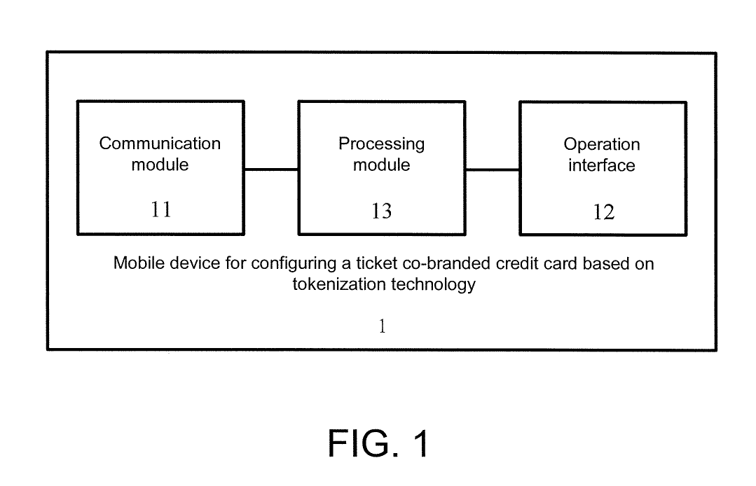

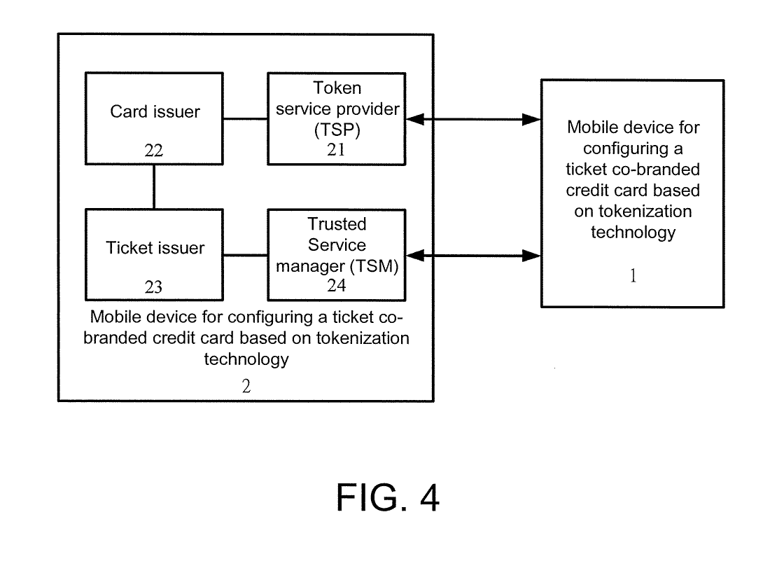

Referring to FIG. 1, FIG. 1 is a system block diagram of a mobile device 1 for configuring a ticket co-branded credit card based on tokenization technology according to a first embodiment of the invention. The mobile device 1 includes a communication module 11, an operation interface 12, and a processing module 13. The communication module 11 is communication connected to an external token service provider (TSP) 21 (see FIG. 4) and an external trusted service manager (TSM) 24 (see FIG. 4), wherein the TSP 21 connects to an external card issuer 22 (see FIG. 4), and the TSM 24 connects to an external ticket issuer 23 (see FIG. 4). The processing module 13 is connected to the communication module 11 and the operation interface 12, and acquires configurations of a ticket co-branded credit card via the operation interface 12, i.e., the communication module 11 transmits a ticket co-branded credit card request to the TSP 21 so as to trigger the TSP 21 to return a corresponding credit card token file, and a ticket co-branding request is submitted to the ticket issuer 23 via the card issuer 22, so that the ticket issuer 23 returns an electronic ticket associated with the credit card token file via the TSP 24.

In another embodiment, the ticket co-branded credit card request from the mobile device 1 further includes at least one of credit card information, ticket information, and software and hardware information.

In another embodiment, the communication module 11 of the mobile device 1 further includes a plurality of heterogeneous communication interfaces. In another embodiment, a communication interface of the mobile device 1 includes a mobile communication interface and a near field communication (NFC) interface.

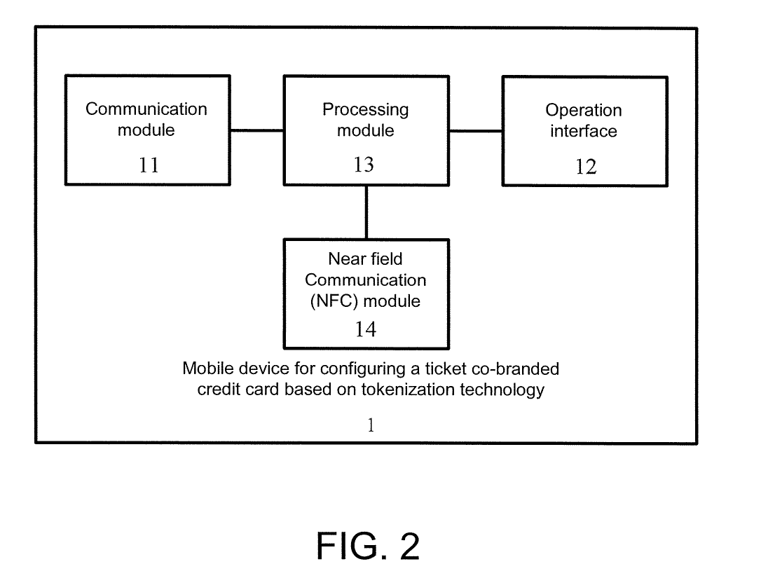

Referring to FIG. 2, in another embodiment, the mobile device 1 further includes an NFC module 14 connected to the processing module 13. The NFC module 14 includes a memory storing an identifier (e.g., a MIFARE identifier) and an NFC identity element (e.g., an NFC subscriber identity module (SIM) card).

In another embodiment, the electronic ticket of the mobile device 1 has an auto load relationship with the credit card token file. In another embodiment, the auto load relationship is that when a balance of the electronic ticket is less than a threshold value, an amount of money is transferred to the electronic ticket from a credit card corresponding to the credit card token file.

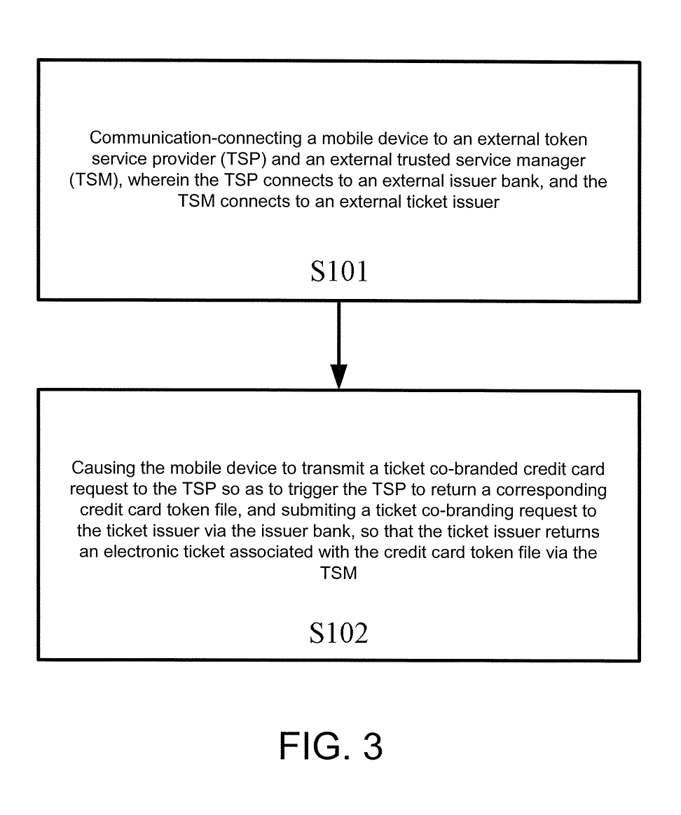

Referring to FIG. 3, FIG. 3 is a method flowchart of a method for configuring a ticket co-branded credit card based on tokenization technology according to a second embodiment of the invention. The method operates in a mobile device and includes the following steps:
S101: communication-connecting the mobile device to an external token service provider (TSP) and an external trusted service manager (TSM), wherein the TSP connects to an external card issuer, and the TSM connects to an external ticket issuer; and
S102: causing the mobile device to transmit a ticket co-branded credit card request to the TSP so as to trigger the TSP to return a corresponding credit card token file, and submitting a ticket co-branding request to the ticket issuer via the card issuer, so that the ticket issuer returns an electronic ticket associated with the credit card token file via the TSM.

In another embodiment, the electronic ticket of the method has an auto load relationship with the credit card token file.

A third embodiment of the invention further provides a computer program product for configuring a ticket co-branded credit card based on tokenization technology, wherein when the computer program product is loaded and executed by a computer, the steps of the above-mentioned method are completed. The computer program product is an application program (APP) executed in a mobile communication device.

Referring next to FIG. 4, FIG. 4 is a system block diagram of an issuance system 2 for configuring a ticket co-branded credit card based on tokenization technology according to a fourth embodiment of the invention. The issuance system 2 includes the TSP 21, the card issuer 22, the ticket issuer 23, and the TSM 24. The TSP 21 connects to the card issuer 22. The TSM 24 connects to the ticket issuer 23. The TSP 21 acquires a ticket co-branded credit card request from the external mobile device 1 (see FIG. 1 or FIG. 2) and transmits a corresponding credit card token file to the mobile device 1, and the card issuer 22 submits a ticket co-branding request to the ticket issuer 23, so that the ticket issuer 23 returns an electronic ticket associated with the credit card token file to the mobile device 1 via the TSM 24.

The following explains the invention in terms of the mobile device 1 for configuring a ticket co-branded credit card based on tokenization technology according to the first embodiment and the issuance system 2 for configuring a ticket co-branded credit card based on tokenization technology according to the fourth embodiment. However, the method for configuring a ticket co-branded credit card based on tokenization technology according to the second embodiment and the computer program product for configuring a ticket co-branded credit card based on tokenization technology according to the third embodiment also have the same or similar technical features and technical effects.

In an exemplary embodiment, the term ticket refers to a transportation ticket (but the type thereof is not limited). After co-branding of the ticket with a credit card is completed, a user having the mobile device 1 may conduct a transaction and make a payment for the ticket at a point of sale (POS) terminal or a ticket system that supports NFC technology.

By means of techniques of the invention, in a token service provided by a third-party token service provider, the mobile device 1 converts a physical credit card into a tokenized credit card, and the tokenized credit card is combined with a non-contact transportation ticket to become a tokenized transportation ticket co-branded credit card. In each credit card transaction, a cardholder may conduct the credit card transaction at a POS terminal of a store using the tokenized transportation ticket co-branded credit card in the mobile device owned by the cardholder themselves. In accordance with an authentication scheme for credit card transactions, the POS terminal transmits a credit card token provided by the mobile device 1 to a credit card transaction system 4 for authentication, so as to obtain, by interpretation, real credit card data of the cardholder and to authorize the credit card transaction. A transaction result is then returned to the mobile device 1 of the cardholder. By the scheme to co-brand and bind a transportation ticket with a credit card, an auto load function can be provided to the co-branded card. When the balance of the transportation ticket is insufficient, the tokenized co-branded card automatically loads a monetary value into the transportation ticket.

The issuance system includes the TSP 21, the card issuer (issuer bank) 22, the ticket issuer 23 and the TSM 24. The mobile device 1 on a client side generally refers to a portable smart device (e.g., a smartphone, a tablet computer, or a wearable electronic device such as smart watch, smart bracelet or the like) having network connection capability and processing capability.

An application program executed in the processing module 13 of the mobile device 1 is used to manage, register, and authenticate the tokenized transportation ticket co-branded credit card. The TSP 21 can be a reliable third-party token service provider, performing tokenization of a credit card by converting real credit card information such as card number into a credit card token, so that the real card number will not be exposed. The card issuer 22 is an issuer bank issuing a physical transportation ticket co-branded credit card. The ticket issuer 23 is an issuance agency issuing the transportation ticket co-branded with the physical transportation ticket co-branded credit card. The TSM 24 downloads an issued ticket over the air (OTA) to the mobile device 1.

The mobile device 1 transmits the credit card information, the transportation ticket information, and information about the mobile device 1 to the TSP 21 that is responsible for generating and providing the credit card token. Next, the card issuer 22 verifies and authenticates the credit card information provided by the client, and then generates a tokenized primary account number (PAN) for transaction control and management. Next, the TSP 21 obtains authorization from the card issuer 22 to generate a specific credit card token. In most preferred embodiments, the TSP 21 may provide services conforming to international standards. For example, both Mastercard and Visa provide services conforming to such standards.

Furthermore, the TSP 21 returns a specific and dedicated credit card token to the mobile device 1, and the processing module 13 provides a tokenized credit card transaction function using the credit card token. The card issuer 22, after verifying and authenticating the credit card information provided by the client, notifies the ticket issuer 23 to register the ticket.

After the ticket is successfully registered, the ticket issuer (transportation ticket operator) 23 returns a message to the card issuer 22 so as to co-brand and bind the ticket with the credit card. The ticket issuer (transportation ticket operator) 23 completes production of the transportation ticket and configuration of the auto load function. Then, by the TSM 24, the client's identity and the NFC SIM card are authenticated, and the transportation ticket is issued OTA to the mobile device 1 on the client side. After the credit card token and the transportation ticket are both downloaded and installed, a tokenized NFC transportation ticket co-branded credit card is installed onto the mobile device 1, and services related to the tokenized transportation ticket co-branded credit card may be provided.

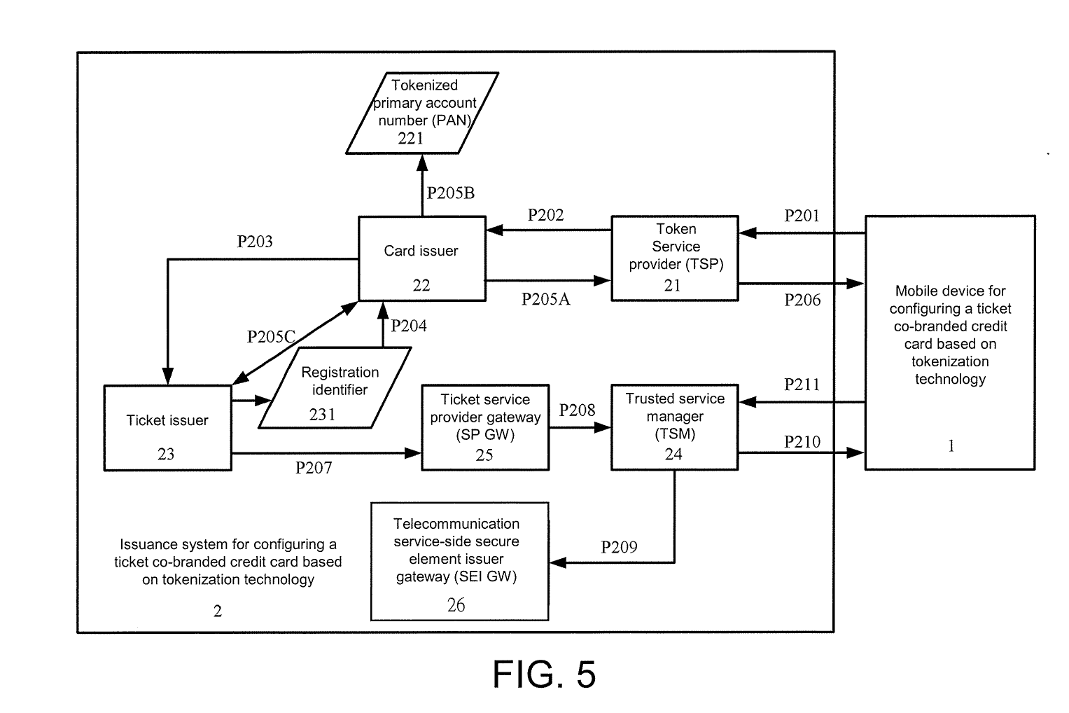

Referring to FIG. 5, FIG. 5 is a flowchart of an exemplary embodiment of the invention. In the present embodiment, application and issuance of a transportation ticket co-branded credit card are tokenized, and an operation procedure thereof is explained as follows.

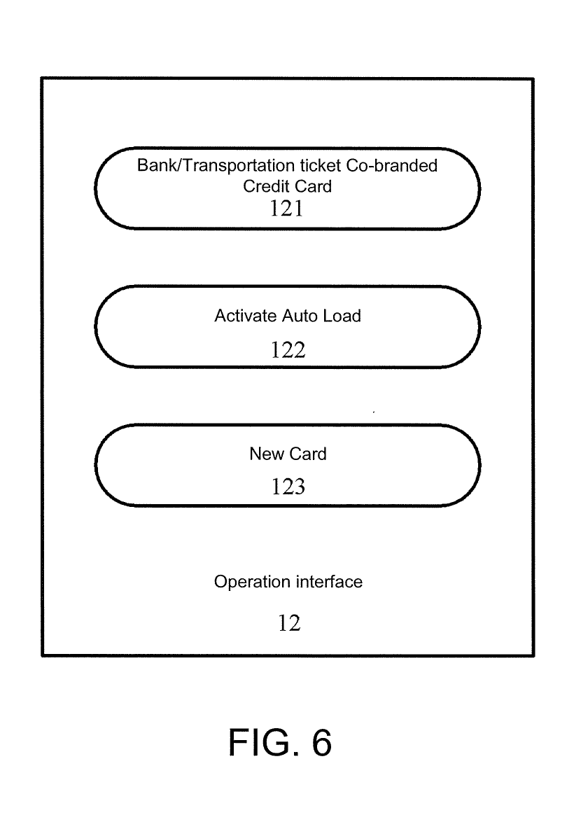

P201: First of all, a client opens an application program on the mobile device 1, and clicks an option 123 (labeled “New Card”) on the operation interface 12 (see FIG. 6) of the application program to provide information related to a physical transportation ticket co-branded credit card, such as card number, expiration date and card verification code, as well as transportation ticket information (e.g., MIFARE ID). The above information related to the transportation ticket co-branded credit card is transmitted to the TSP 21 via the Internet. Meanwhile, the software and hardware information related to the mobile device 1 is also provided for a back end (an issuer bank or a transportation ticket operator) to confirm whether the mobile device 1 can be used for tokenization for the issuance of the transportation ticket co-branded credit card.

P202: The TSP 21, after receiving the credit card information (card info) about the transportation ticket co-branded credit card, notifies the card issuer (issuer bank) 22 to authenticate the identity of the cardholder of the transportation ticket co-branded credit card and to authenticate the mobile device 1.

P203: The card issuer (issuer bank) 22 confirms that the physical transportation ticket co-branded credit card is legal and that the software and hardware of the mobile device 1 of the applicant conform to requirements for tokenizing the credit card. Then, the card issuer 22 notifies the ticket issuer (transportation ticket operator) 23 to register a ticket using the applicant's phone number and MIFARE ID, thus generating a registration identifier 231.

P204: After the transportation ticket is successfully registered, the ticket issuer (transportation ticket operator) 23 returns a message to the card issuer 22 so as to co-brand and bind the transportation ticket with the credit card.

P205A: The card issuer 22, after confirming that the relevant information provided by the applicant is correct, notifies the TSP 21 to generate a credit card token.

P205B: The card issuer 22 generates a tokenized primary account number (PAN) 221 via a security mechanism for distinction from the card number of the physical credit card (the tokenized PAN 221 is different from the card number of the original physical credit card, the credit card transaction is tokenized, and transaction data will be summarized in the account of the original physical credit card after a mapping process).

P205C: After confirming that the co-branding and binding scheme (P204) is completed, the ticket issuer (transportation ticket operator) 23 produces the transportation ticket and sets the auto load function (as long as the cardholder has activated the auto load function, the tokenized credit card will automatically load a monetary value into the transportation ticket when the balance of the transportation ticket is insufficient.)

P206: The TSP 21 issues the credit card token to the mobile device 1. When the mobile device 1 obtains the credit card token, the application program operating in the processing module 13 is imparted with the tokenized credit card transaction function.

P207: An OTA issuance of the transportation ticket is performed in which the ticket issuer (transportation ticket operator) 23 notifies a ticket service provider gateway (SP GW) 25 that a transportation ticket is available for download.

P208: At this moment, the SP GW 25 notifies the corresponding TSM 24 that a transportation ticket is available for OTA download.

P209: The TSM 24 submits a request to a telecommunication service-side secure element issuer gateway (SEI GW) 26 for verifying validity of the NFC SIM card in the mobile device 1 of the client. Then, an internal system of the corresponding telecommunication service verifies the client's identity and the validity of the NFC SIM card.

P210: The TSM 24, after receiving a successful confirmation message returned by the telecommunication service-side SEI GW 26, notifies the corresponding mobile device 1 to download the transportation ticket.

P211: The application program executes an OTA download and then installs the transportation ticket onto the NFC SIM 24 of the mobile device 1. After the credit card token and the transportation ticket are both installed, a tokenized transportation ticket co-branded credit card is installed onto the mobile device 1 for use. A summary of information about this card may be found on a user interface of the application program.

Referring to FIG. 6, FIG. 6 is a schematic diagram of the operation interface 12 of the mobile device 1. In this exemplary example, the operation interface 12 is a touch screen (but the type thereof is not limited). The operation interface 12 in FIG. 6 is also the user interface of the application program. The user may click the option 123 (labeled “New Card”) to convert a physical transportation ticket co-branded credit card into a tokenized transportation ticket co-branded credit card. The tokenized transportation ticket co-branded credit card is installed onto the mobile device 1, and an option 121 (labeled “Bank/Transportation ticket Co-branded Credit Card”) for the newly generated tokenized credit card will be seen on the user interface of the application program, which includes a credit card token and MIFARE transportation ticket. In addition, the user may utilize the card function configuration option on the user interface of the application program and click an option 122 (labeled “Activate Auto Load”) to activate the auto load function. Accordingly, the tokenized credit card will automatically load a monetary value into the transportation ticket when the balance of the transportation ticket is insufficient.

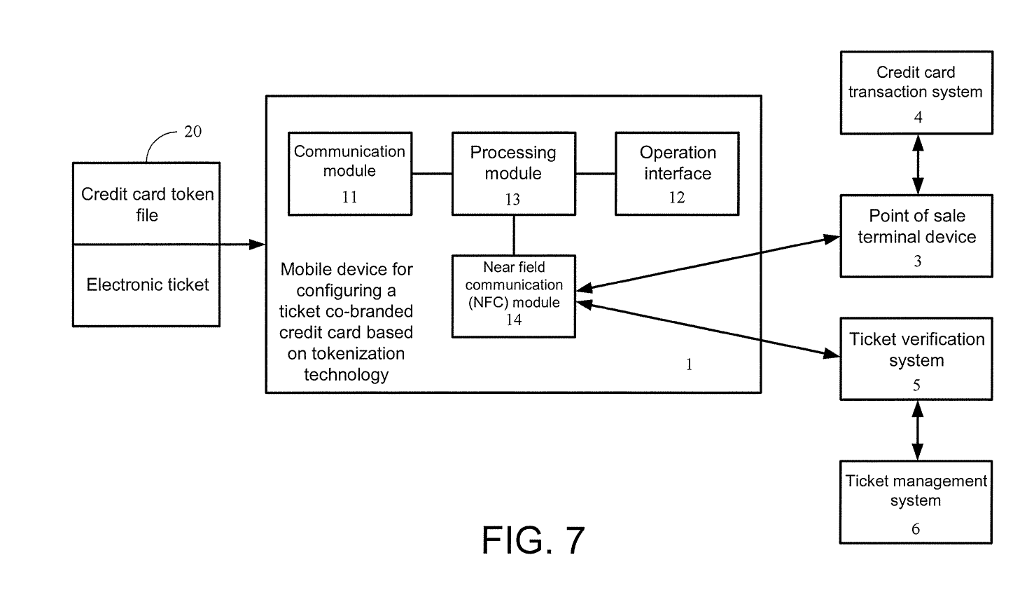

Referring to FIG. 7, FIG. 7 is a schematic diagram of an application scenario according to the invention. In this application scenario, if the mobile device 1 has acquired a tokenized transportation ticket co-branded credit card 20. When the mobile device 1 of the user has the NFC module 14 and a POS terminal device 3 of a store also supports the NFC function, an NFC credit card transaction may be conducted.

During the transaction, the mobile device 1 transmits the credit card token to the POS terminal device 3 of the store, and the POS terminal device 3 transmits the content of the transaction and the credit card token to a back-end credit card transaction system 4, so as to request verification of validity of the credit card and transaction authorization processing. Steps of verification of the credit card token of the credit card transaction system 4 are as follows. (1) A tokenized PAN corresponding to the credit card token is found. (2) The status and expiration date of the credit card token are examined. After the credit card token is confirmed to be valid for credit card transactions, the credit card token and the corresponding tokenized PAN are transmitted to the card issuer 22 (see FIG. 5) to request transaction authorization. The card issuer 22 processes the transaction authorization and then returns a result of the transaction authorization to the TSP 21 (see FIG. 5). The TSP 21 then returns the authorization to the POS terminal device 3 of the store to process the final transaction authorization. Finally, the transaction information is returned to the mobile device 1 to complete the credit card transaction.

In addition, when the user intends to carry out a ticket transaction using the tokenized transportation ticket co-branded credit card 20, they may carry out the transportation ticket transaction by using the mobile device 1 having the NFC function to communicate with a ticket verification system 5. When the balance of the transportation ticket is insufficient, the ticket verification system 5 transmits a load request to a back-end ticket management system (ticket operator) 6 and the credit card transaction system 4. After it is confirmed that the user has set the auto load function, the tokenized credit card will automatically load a monetary value into the transportation ticket.

The above detailed descriptions relate to a possible implementation of the invention. However, the implementation is not intended to limit the protection scope of the invention, and any equivalent implementations or modifications without departing the spirit of the invention shall fall within the protection scope of the invention.

What is claimed is:

1. A mobile device for configuring a ticket co-branded credit card based on tokenization technology, the mobile device comprising:
a communication module, communication connected to an external token service provider (TSP) and an external trusted service manager (TSM), wherein the TSP connects to an external card issuer, and the TSM connects to an external ticket issuer;
an operation interface; and
a processing module, connected to the communication module and the operation interface, wherein the processing module acquires configurations of a ticket co-branded credit card via the operation interface, i.e., the communication module transmits a ticket co-branded credit card request to the TSP so as to trigger the TSP to return a corresponding credit card token file, and a ticket co-branding request is submitted to the ticket issuer via the card issuer, so that the ticket issuer returns an electronic ticket associated with the credit card token file via the TSP.

2. The mobile device for configuring a ticket co-branded credit card based on tokenization technology according to claim 1, wherein the ticket co-branded credit card request further comprises at least one of credit card information, ticket information, and software and hardware information.

3. The mobile device for configuring a ticket co-branded credit card based on tokenization technology according to claim 1, wherein the communication module further comprises a plurality of heterogeneous communication interfaces.

4. The mobile device for configuring a ticket co-branded credit card based on tokenization technology according to claim 3, wherein the communication interfaces comprise a mobile communication interface and a near field communication (NFC) interface.

5. The mobile device for configuring a ticket co-branded credit card based on tokenization technology according to claim 1, wherein the electronic ticket has an auto load relationship with the credit card token file.

6. The mobile device for configuring a ticket co-branded credit card based on tokenization technology according to claim 5, wherein the auto load relationship is that when a balance of the electronic ticket is less than a threshold value, an amount of money is transferred to the electronic ticket from a credit card corresponding to the credit card token file.

7. A method for configuring a ticket co-branded credit card based on tokenization technology, the method operating in a mobile device and comprising:
communication-connecting the mobile device to an external token service provider (TSP) and an external trusted service manager (TSM), wherein the TSP connects to an external card issuer, and the TSM connects to an external ticket issuer; and
causing the mobile device to transmit a ticket co-branded credit card request to the TSP so as to trigger the TSP to return a corresponding credit card token file, and submitting a ticket co-branding request to the ticket issuer via the card issuer, so that the ticket issuer returns an electronic ticket associated with the credit card token file via the TSM.

8. The method for configuring a ticket co-branded credit card based on tokenization technology according to claim 7, wherein the electronic ticket has an auto load relationship with the credit card token file.

9. A computer program product for configuring a ticket co-branded credit card based on tokenization technology, wherein when the computer program product is loaded and executed by a computer, the method according to claim 7 is completed.

10. A computer program product for configuring a ticket co-branded credit card based on tokenization technology, wherein when the computer program product is loaded and executed by a computer, the method according to claim 8 is completed.

11. An issuance system for configuring a ticket co-branded credit card based on tokenization technology, the issuance system comprising:
a card issuer;
a token service provider (TSP) connecting to the card issuer;
a ticket issuer;
a trusted service manager (TSM) connecting to the ticket issuer;
wherein the TSP acquires a ticket co-branded credit card request from an external mobile device and transmits a corresponding credit card token file to the mobile device, and the card issuer submits a ticket co-branding request to the ticket issuer, so that the ticket issuer returns an electronic ticket associated with the credit card token file to the mobile device via the TSM.
